(19) United States
(12) Patent Application Publication
(10) Pub. No.: US 2020/0110890 A1
(43) Pub. Date: Apr. 9, 2020

(54) MULTI DEVICE SYSTEM AND METHOD OF CONTROLLING THE SAME

(71) Applicants: Hyundai Motor Company, Seoul (KR); Kia Motors Corporation, Seoul (KR)

(72) Inventors: Seunghyun Woo, Seoul (KR); Dong-Seon Chang, Hwaseong-si (KR); Daeyun An, Anyang-si (KR)

(21) Appl. No.: 16/560,319

(22) Filed: Sep. 4, 2019

(30) Foreign Application Priority Data
Oct. 8, 2018 (KR) 10-2018-0119641

(51) Int. Cl. G06F 21/60; H04W 4/80; G06K 9/00; G06T 11/00

(52) U.S. Cl. CPC G06F 21/604; H04W 4/80; H04L 67/12; G06K 9/00335; G06T 11/00; G06K 9/00302

(57) ABSTRACT

A multi device system includes: a token configured to give access rights related to a user's emotional information to an electronic device; and a user terminal configured to: obtain the user's emotional information, transmit the user's emotional information to the token, and control the electronic device to which the access rights is given through the token to perform a function corresponding to the user's emotional information.

### CROSS-REFERENCE TO RELATED APPLICATION(S)

This application is based on and claims priority under 35 U.S.C. § 119 to Korean Patent Application No. 10-2018-0119641, filed on Oct. 8, 2018 in the Korean Intellectual Property Office, the disclosure of which is incorporated by reference in its entirety.

### TECHNICAL FIELD

The present disclosure relates to a multi device system and a method of controlling the multi device system for providing a user's emotional information to an electronic device using a medium called a token, and more particularly, to a multi device system in which a user gives access rights to emotional information to an electronic device providing the user's own emotional information using a token, and a method of controlling the multi device system.

### BACKGROUND

In recent years, devices equipped with artificial intelligence and operated in response to a user's emotion have been emerging, and technologies for sharing information among various devices and interacting with each other are emerging. For example, attempts have been made to reflect the user's emotion in Internet of Things (IoT).

However, under a condition where various devices share a network and share data, there is security vulnerability, and a user's emotional information may be used differently from that of the intention of the user. In addition, when the user cannot control an object to which the user's own emotional information is provided, the user may feel anxiety and a negative emotion.

Therefore, even when various devices are operated based on the user's emotion, there is a need for a technology that allows the user to have a right to choose in providing the own emotional information.

### SUMMARY

It is an aspect of the present disclosure to provide a multi device system for preventing a user's emotional information from being used by a plurality of devices without the user's permission by selecting a device that can access his/her own emotional information, and a method of controlling the multi device system.

It is another aspect of the present disclosure to provide a multi device system for facilitating the interaction between the user and the plurality of devices by transmitting the user's emotional information through a medium called a token without adding a separate device for emotion recognition to each of the plurality of devices, and a method of controlling the multi device system.

Additional aspects of the present disclosure will be set forth in part in the description which follows and, in part, will be obvious from the description, or may be learned by practice of the present disclosure.

In accordance with an exemplary embodiment of the present disclosure, a multi device system includes: a token configured to give access rights related to user's emotional information to an electronic device; and a user terminal configured to obtain the user's emotional information, transmit the user's emotional information to the token, and control the electronic device to which the access rights is given through the token to perform a function corresponding to the user's emotional information.

The user terminal may collect the user's bio-signal using a bio-signal sensor included in the user terminal, and may obtain the user's emotional information based on the user's bio-signal.

The user terminal may further collect at least one of facial expression data of the user and gesture data of the user using a camera included in the user terminal, and may obtain the user's emotional information based on at least one of the user's bio-signal, the facial expression data of the user, and the gesture data of the user.

The user terminal may classify the user's emotion according to a predetermined reference corresponding to the user's bio-signal, and may obtain the user's emotional information based on the classification result.

The token may transmit the received user's emotional information to the electronic device, to extract feature information of the electronic device, and may transmit the extracted feature information to the user terminal. The user terminal may generate feedback information corresponding to the user's emotional information by reflecting the feature information of the electronic device.

The user terminal may communicate with an external server to further collect the user's situation information including at least one of current location, current time, weather, and user schedule information, and may generate the feedback information by reflecting the user's situation information.

The feedback information may include at least one of function information of the executable electronic device corresponding to the user's emotional information and an emotional expression image corresponding to the user's emotional information.

The user terminal may generate a control signal for performing a specific function, and may transmit the control signal to the electronic device when the specific function among the function information of the executable electronic device is selected by the user.

The user terminal may obtain an image of a space including the token and the electronic device, and may output an augmented reality image by overlapping the feedback information with the image.

In accordance with another exemplary embodiment of the present disclosure, a multi device system includes: a user terminal configured to generate a virtual token that gives access rights to a user's emotional information according to the user's request, and generate and output feedback information corresponding to the user's emotional information by obtaining the user's emotional information; and an electronic device configured to obtain the access rights by receiving the virtual token from the user terminal, and perform a function corresponding to the user's emotional information under a control of the user terminal.

In accordance with another exemplary embodiment of the present disclosure, a method of controlling a multi device system includes: connecting a token, a user terminal and an electronic device, and receiving access rights to a user's emotional information from the token; providing, by the token, the access rights to the electronic device; obtaining the user's emotional information using the user terminal, and transmitting, by the user terminal, the user's emotional information to the token; and controlling, by the user terminal, the electronic device to perform a function corresponding to the user's emotional information by transmitting a control signal to the electronic device.

The transmitting the user's emotional information may further include collecting the user's bio-signal; and obtaining the user's emotional information based on the user's bio-signal.

The transmitting the user's emotional information may further include transmitting the user's emotional information to the electronic device when a connection completion signal between the token and the electronic device is received at the user terminal.

The transmitting the user's emotional information may further include collecting at least one of facial expression data of the user and gesture data of the user using a camera included in the user terminal; and obtaining the user's emotional information based on at least one of the user's bio-signal, the facial expression data of the user, and the gesture data of the user.

The transmitting the user's emotional information may further include classifying the user's emotion according to a predetermined reference corresponding to the user's bio-signal; and obtaining the user's emotional information based on the classification result.

The method may further include: generating, by the user terminal, feedback information corresponding to the user's emotional information by reflecting feature information of the electronic device extracted by the token.

The generating the feedback information may further include communicating with an external server to collect the users situation information including at least one of current location, current time, weather, and user schedule information; and generating the feedback information by reflecting the user's situation information.

The feedback information may include at least one of function information of the executable electronic device corresponding to the user's emotional information and an emotional expression image corresponding to the user's emotional information.

The controlling the electronic device may further include generating a control signal for performing a specific function, and transmitting the control signal to the electronic device when the specific function among the function information of the executable electronic device is selected by the user.

In accordance with another exemplary embodiment of the present disclosure, a method of controlling a multi device system includes: generating, by a user terminal, a virtual token that gives access rights to a user's emotional information; transmitting, by the user terminal, the virtual token to an electronic device to give the access rights to the electronic device; obtaining the user's emotional information using the user terminal; generating and outputting, by the user terminal, feedback information corresponding to the user's emotional information; and performing, by the electronic device, a function corresponding to the user's emotional information under a control of the user terminal.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a view illustrating a structure of a multi device system of a vehicle according to an exemplary embodiment of the present disclosure;

FIG. 2 is a view illustrating an example of implementation of a multi device system according to an exemplary embodiment of the present disclosure;

FIG. 3 is a view illustrating a configuration of token hardware according to an exemplary embodiment of the present disclosure;

FIG. 4 is a view illustrating an interior configuration of a user terminal according to an exemplary embodiment of the present disclosure;

FIG. 5 is a view illustrating a detailed configuration of a user terminal controller according to an exemplary embodiment of the present disclosure;

FIG. 6 is a view for describing a method of obtaining a user's emotional information using a user terminal according to an exemplary embodiment of the present disclosure; and

FIGS. 7 to 9 are flowcharts for describing a method of controlling a multi device system according to an exemplary embodiment of the present disclosure.

### DETAILED DESCRIPTION

Like reference numerals refer to like elements throughout the specification. Not all elements of embodiments of the present disclosure will be described, and description of what are commonly known in the art or what overlap each other in the embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be understood that when an element is referred to as being “connected” to another element, it can be directly or indirectly connected to the other element, wherein the indirect connection includes “connection” via a wireless communication network.

Further, when a part “includes” or “comprises” an element, unless there is a particular description contrary thereto, the part may further include other elements, not excluding the other elements.

It will be understood that, although the terms first, second, third, etc., may be used herein to describe various elements, it should not be limited by these terms. These terms are only used to distinguish one element from another element.

In addition, the terms used herein are used to illustrate the embodiments and are not intended to limit and/or restrict the disclosure. As used herein, the singular forms “a,” “an” and “the” are intended to include the plural forms as well, unless the context clearly indicates otherwise.

An identification code is used for the convenience of the description but is not intended to illustrate the order of each step. Each of the steps may be implemented in an order different from the illustrated order unless the context clearly indicates otherwise.

The principle and embodiments of the present disclosure will now be described with reference to the accompanying drawings.

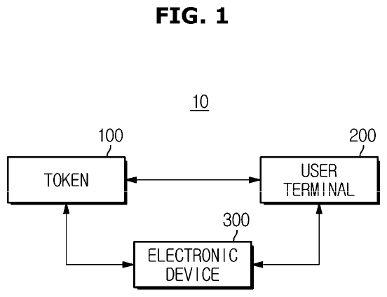

FIG. 1 is a view illustrating a structure of a multi device system of a vehicle according to an exemplary embodiment of the present disclosure.

Referring to FIG. 1, a multi device system 10 may include a token 100, a user terminal 200, and an electronic device 300.

The token 100 may be used for giving access rights to a user's emotional information to the electronic device 300. The token 100 may be implemented in hardware or software.

When the token 100 is implemented in hardware, the token 100 may be connected to the electronic device 300 to give the electronic device 300 the access rights to the user's emotional information. Wherein, “connected” may include both wired connection and wireless connection, and may be understood as being paired between specific devices. The token 100 may be connected to the electronic device 300 using short-range communication. The short-range communication may be a concept that includes all methods capable of transmitting and receiving data between devices between a very short distance, such as Near Field Communication (NFC) and Radio Frequency Identification (RFID).

When the access rights to the user's emotional information is given to the electronic device 300, the token 100 may generate an access authorization completion signal and transmit the access authorization completion signal to the user terminal 200.

The token 100 may also be connected to the user terminal 200 when connected to the electronic device 300 and may transmit a connection completion signal of the token 100 and the electronic device 300 to the user terminal 200. The token 100 may use various communication methods as well as the short-range communication when the user terminal 200 is connected. For example, wireless fidelity (Wi-Fi), Bluetooth, Zigbee, Ultra-Wide Band (UWB) communication, or the like may be used.

When the token 100 is implemented in software, the token 100 may be a virtual token generated by the user terminal 200. That is, when there is a user's request, the user terminal 200 may generate the virtual token and transmit the generated virtual token to the electronic device 300. The electronic device 300 may receive the virtual token and have the access rights to the user's emotional information. The generation and transmission of the virtual token may be performed by a specific application installed in the user terminal 200.

The user terminal 200 may obtain the user's emotional information. That is, when the user gives the access rights to his/her emotional information to the electronic device 300 using the token 100, the user terminal 200 may obtain the user's emotional information from data collected by a bio-sensor, a camera, or the like. The user terminal 200 transmits the obtained user's emotional information to the electronic device 300.

On the other hand, the user terminal 200 may generate a query signal to confirm whether the granting of the access rights to the user's emotional information is completed to the electronic device 300, and transmit the generated query signal to the token 100. When the access authorization completion signal from the token 100 is received, the user terminal 200 may transmit the user's emotional information to the electronic device 300. In other words, the user terminal 200 may transmit the obtained user's emotional information to the electronic device 300 when the access rights to the user's emotional information are given to the electronic device 300.

The user terminal 200 may be implemented as a mobile terminal such as a smart phone, or may be implemented as a wearable device in the form of a watch, a cap, or a pair of glasses worn on a part of the user's body.

The electronic device 300 may be a device capable of performing various functions in accordance with the user's emotional information. The electronic device 300 may be a vehicle. The electronic device 300 may be connected to the token 100 to receive the access rights to the user's emotional information and receive the user's emotional information. The electronic device 300 may transmit feature information of the electronic device 300 to the user terminal 200 upon receiving at least one of the user's emotional information and the access rights to the user's emotional information. The feature information of the electronic device 300 may include the type, function, operating state information or the like of the electronic device 300.

The user terminal 200 may generate feedback information corresponding to the user's emotional information by reflecting the feature information of the electronic device 300. The feedback information may include at least one of the function information of the executable electronic device 300 corresponding to the user's emotional information and an emotional expression image corresponding to the user's emotional information.

Particularly, the user terminal 200 may output the function information of the executable electronic device 300 to improve the user's emotion to a positive emotion when the user's emotional information is a negative emotion such as an anger emotion or a sad emotion. For example, when the electronic device 300 is a robot having various functions, the feedback information may include function information of the robot that can be executed to improve or maintain the user's emotion with the positive emotion.

In addition, the user terminal 200 may output the emotional expression image to be output in response to the user's emotion according to the emotional expression image expressing positive or negative emotions of the user or according to a reference. The emotional expression image may include both a static image and a dynamic image, and may include a picture, an emoticon, an avatar, etc. that can express emotions.

In addition, the user terminal 200 may further collect the user's situation information including at least one of current location, current time, weather, and user schedule information through an external server (not shown) or the user's input, and the feedback information may be generated by further reflecting the user's situation information. When the user operates the vehicle, the user's situation information may further include road information, road traffic situation information, and the like.

The user terminal 200 may generate a control signal for performing a specific function when the specific function among the function information of the executable electronic device 300 is selected by the user or when execution of the specific function is required even without the user's selection, and transmit a generated control signal to the electronic device 300. The electronic device 300 receives the control signal and performs the specific function. For example, as the function information of the executable electronic device 300, a plurality of functions such as music play, image play, shopping information provision, and optimal path provision may be presented. When the user selects the music play function using the user terminal 200, the user terminal 200 may generate the control signal for music play and transmit the generated control signal to the electronic device 300. The electronic device 300 may receive the control signal to play the music.

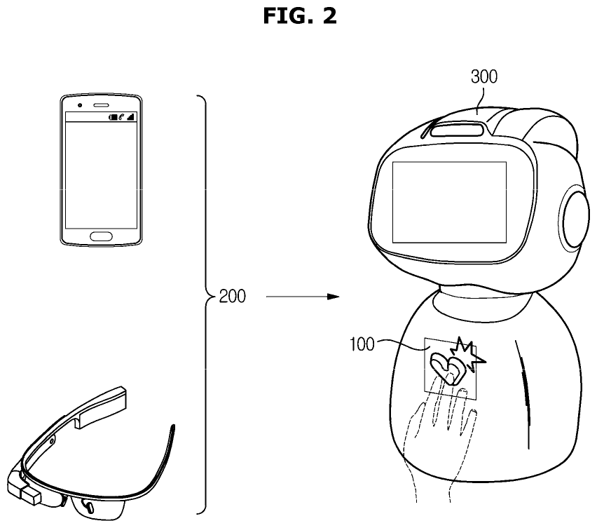

FIG. 2 is a view illustrating an example of implementation of a multi device system according to an exemplary embodiment of the present disclosure.

Referring to FIG. 2, when the token 100 is implemented in hardware, the token 100 may have various shapes. In FIG. 2, the token 100 may have a heart shape. The user terminal 200 may be implemented as a mobile terminal such as a smart phone, or may be implemented as a wearable device in the form of the watch, the cap, or the pair of glasses worn on the part of the user's body. The electronic device 300 may be capable of performing various functions in accordance with the user's emotional information, and may include various devices such as the vehicle, the robot, and a home appliance.

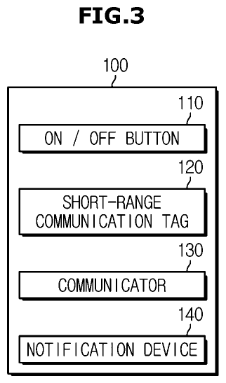

FIG. 3 is a view illustrating a configuration of token hardware according to an exemplary embodiment of the present disclosure.

Referring to FIG. 3, when the token 100 is implemented in hardware, the token 100 may include an on/off button 110 for operating operations, a short-range communication tag 120 for short-range communication, a communicator 130 for performing communication other than short-range communication, and a notification device 140 for indicating the on/off state of the token 100 and the state of pairing of the token 100 with the user terminal 200 and the electronic device 300.

The short-range communication tag 120 may be a NFC tag and/or an RFID tag. The communicator 130 may transmit and receive data using the Wi-Fi, the Bluetooth, the Zigbee, and the UWB communication method.

The notification device 140 may include at least one of a vibration device, a sound device, and an LED device to provide state information of the token 100 using at least one of vibration, sound, and light.

When the token 100 is implemented by software, the output device included in the user terminal 200 may be used to inform the user whether the transmission of the token 100 is completed to the electronic device 300.

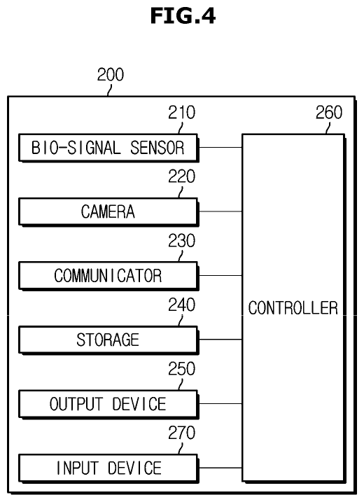

FIG. 4 is a view illustrating an interior configuration of a user terminal according to an exemplary embodiment of the present disclosure.

Referring to FIG. 4, the user terminal 200 may include a bio-signal sensor 210, a camera 220, a communicator 230, a storage 240, an output device 250, a controller 260, and an input device 270.

The bio-signal sensor 210 may collect the user's bio-signal. The bio-signal sensor 210 may include a galvanic skin response (GSR) sensor for measuring skin electrical conductivity of the user, a skin temperature sensor for measuring a skin temperature of the user, a heart rate (HR) sensor for measuring a heart rate of the user, an electroencephalogram (EEG) sensor for measuring brainwaves of the user, and a voice recognition sensor for measuring a voice signal of the user.

The camera 220 may be a device for obtaining an image, and may convert the captured image of the user into data and store the converted data. In addition, the camera 220 may obtain the image of a space including the token 100 and the electronic device 300.

The communicator 230 may connect the user terminal 200 to the token 100 and the electronic device 300, and may transmit/receive data. The communicator 230 may use various communication methods such as the Wi-Fi, the Bluetooth, the Zigbee, and the UWB communication method. In addition, the communicator 230 may communicate with the external server (not shown) to transmit/receive data.

As described above, when the access rights to the user's emotional information is given to the electronic device 300, the token 100 may generate the access authorization completion signal and transmit the access authorization completion signal to the user terminal 200. That is, the communicator 230 may receive the access authorization completion signal from the token 100.

The storage 240 may store the bio-signal collected by the bio-signal sensor 210, facial expression data and gesture data of the user collected by the camera 220, and may store an emotion model used to obtain the user's emotional information. The user's emotional information acquisition and emotion model will be described later.

The output device 250 may include at least one of a display, a projector, a speaker, and the vibration device. The output device 250 may visually output the user's emotional information and the feedback information corresponding to the user's emotional information through the display or the projector, and may output sound information through the speaker and may also output a haptic response through the vibration device. The output device 250 may output an augmented reality (AR) image by overlapping the feedback information with the image of the space including the token 100 and the electronic device 300.

The controller 260 may control the bio-signal sensor 210, the camera 220, the communicator 230, the storage 240, and the output device 250, process the information received through the bio-signal sensor 210 and the camera 220, and generate the control signal for controlling the electronic device 300. The controller 260 will be described in detail with reference to FIG. 4.

The input device 270 may receive at least one of the user's situation information, the user's emotional information, and a function execution command from the user. The input device 270 may be a voice recognition device capable of recognizing the user's voice, and may be a touch panel receiving a touch input of the user. The input device 270 may be implemented as a variety of devices capable of receiving a user input.

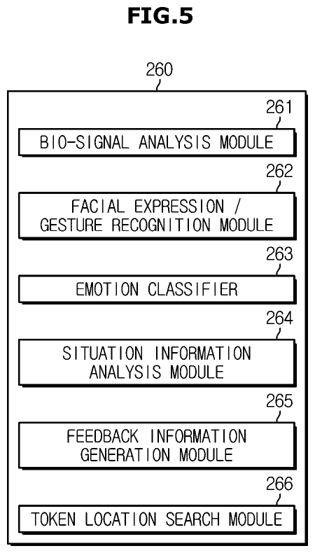

FIG. 5 is a view illustrating a detailed configuration of a user terminal controller according to an exemplary embodiment of the present disclosure.

Referring to FIG. 5, the controller 260 may include a bio-signal analysis module 261, a facial expression/gesture recognition module 262, an emotion classifier 263, a situation information analysis module 264, a feedback information generation module 265, and a token location search module 266.

The bio-signal analysis module 261 may receive the bio-signals collected by the bio-signal sensor 210, and may perform pre-processing such as filtering for removing noise included in the bio-signal, amplification of the bio-signals, and conversion to a digital signal. The bio-signal analysis module 261 may extract the bio-signal within a predetermined signal range through a pre-processing process and determine the bio-signal as an effective signal. For example, when the collected skin temperature is within a predetermined temperature range (30° C. to 37° C.), the bio-signal may be extracted as the effective signal.

In addition, the bio-signal analysis module 261 may extract a feature point by normalizing an effective bio-signal and analyzing the waveform of the normalized bio-signal. For example, the bio-signal analysis module 261 may decompose the waveform of the bio-signal into one or more constituent pulses and extract the feature point from the decomposed constituent pulses. The feature point may include, but is not limited to, the time, amplitude, average time, standard deviation, and amplitude information of the whole bio-signal waveform of the constituent pulses. In addition, the bio-signal analysis module 261 may pattern the feature point.

The facial expression/gesture recognition module 262 may receive the image data of the user captured by the camera 220, and may extract and recognize facial expression data of the user or gesture data of the user using various facial expression recognition algorithms or gesture recognition algorithms. For example, the facial expression/gesture recognition module 262 may recognize facial expressions or gestures of the user using CNN (Convolutional Neural Network), which is a deep learning technique. Since the object recognition technique using the CNN is a well-known technique, a detailed description will be omitted.

The emotion classifier 263 may classify the user's emotion according to a predetermined reference corresponding to the user's bio-signal. That is, the emotion classifier 263 may classify the user's emotion according to the predetermined reference corresponding to the feature points of the bio-signal patterned by the bio-signal analysis module 261. Here, the predetermined reference may refer to an emotion model. The emotion model may classify emotions according to the feature point pattern of the bio-signal.

The emotion classifier 263 may generate the emotion model using correlation information between the user's bio-signal and emotion. Correlation information between the user's bio-signal and emotion may be stored in the storage 240 or received from the external server.

The emotion model may be a Russell's emotion model. The Russell's emotion model may be expressed by a two-dimensional graph based on the x-axis and the y-axis, and may classify emotions to eight areas that are joy (0 degrees), excitement (45 degrees), arousal (90 degrees), pain (135 degrees), unpleasantness (180 degrees), depression (225 degrees), sleepiness (270 degrees), and relaxation (315 degrees). In addition, the eight areas may be divided into a total of 28 emotions that are classified into similar emotions belonging to the eight areas. That is, the emotion classifier 263 may classify the user's emotion corresponding to the feature point extracted for each user's bio-signal based on the emotion model.

The emotion classifier 263 may classify the user's emotion according to the predetermined reference corresponding to the user's facial expression data or gesture data. That is, the emotion classifier 263 may classify the user's emotion using the emotion model classified according to the facial expression change pattern or the emotion model classified according to the gesture change pattern of the user. The emotion model may be stored in the storage 240.

The emotion classifier 263 may classify the user's emotion based on at least one of the user's bio-signal, the facial expression data and gesture data of the user, and may generate the user's emotional information based on the classification result. The storage 240 may store the user's emotional information.

The situation information analysis module 264 may analyze the user's situation based on at least one of the current location, current time, weather, and user schedule information received from the external server or the input device 270. For example, when the user is presently at home and the current time is 8:50 AM and there is a schedule for work by 9:00 AM, the situation information analysis module 264 may analyze the user as likely to perceive the information. When the user operates the vehicle, the situation information analysis module 264 may receive and analyze the road information, the road traffic situation information, and the like.

The result of analyzing the user's situation information by the situation information analysis module 264 may be used in generating the feedback information together with the user's emotional information. For example, since the user's perception is imminent as the feedback information, an avatar image with an unstable facial expression may be generated.

The feedback information generation module 265 may generate the feedback information corresponding to at least one of the user's emotional information and the user's situation information. The feedback information generation module 265 may reflect the feature information of the electronic device 300 to generate the feedback information. The feedback information may include at least one of the function information of the executable electronic device 300 corresponding to at least one of the user's emotional information and the user's situation information, and the emotional expression image corresponding to the user's emotional information.

For example, when the user's emotional information is the negative emotion such as the anger emotion or the sad emotion, the feedback information generation module 265 may generate and output the function information of the executable electronic device 300 as the feedback information to improve the user's emotion with the positive emotion. Particularly, when the electronic device 300 is the robot having various functions, the feedback information may include function information of the executable robot to improve or maintain the user's emotion with the positive emotion.

In addition, the feedback information generation module 265 may generate and output the emotional expression image to be output in response to the user's emotion as the feedback information according to the emotional expression image expressing the positive or negative user's emotion or the predetermined reference. The emotional expression image may include both the static image and the dynamic image, and include the picture, the emoticon, the avatar, etc. that can express emotions.

The token location search module 266 may track a location of the token 100 and return location data of the token 100. When the token 100 is implemented in hardware, the token location search module 266 may track the location of the token 100 in the image data obtained through the camera 220. When the token 100 is implemented in software, the token location search module 266 may return the location data of the electronic device 300 to which the token 100 was transmitted. The location data of the token 100 returned by the token location search module 266 may be used to confirm whether the token 100 is connected to the electronic device 300.

The token location search module 266 may generate the query signal to confirm whether the granting of the access rights to the user's emotional information is completed to the electronic device 300, and transmit the query signal generated through the communicator 230 to the token 100.

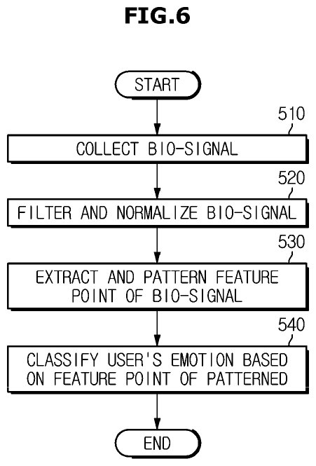

FIG. 6 is a view for describing a method of obtaining a user's emotional information using a user terminal according to an exemplary embodiment of the present disclosure.

Referring to FIG. 6, the controller 260 of the user terminal 200 may classify the user's emotion based on the user's bio-signal received from the bio-signal sensor 210 and generate the user's emotional information.

The controller 260 may receive the user's bio-signal from the bio-signal sensor 210 (510). The controller 260 may perform the pre-processing such as filtering for removing noise included in the bio-signal, amplification of the bio-signals, conversion to the digital signal to extract the effective bio-signal and normalize the extracted effective bio-signal (520). Thereafter, the controller 260 may analyze the waveform of the normalized bio-signal to extract the feature point and pattern the extracted feature point (530). The controller 260 may decompose the waveform of the bio-signal into one or more constituent pulses and extract the feature point from the decomposed constituent pulses. The feature point may include, but is not limited to, the time, amplitude, average time, standard deviation, and amplitude information of the whole bio-signal waveform of the constituent pulses.

The controller 260 may classify the user's emotion according to the predetermined reference corresponding to the feature point of the patterned bio-signal (540). The controller 260 may generate the user's emotional information based on the classification result of the user's emotion.

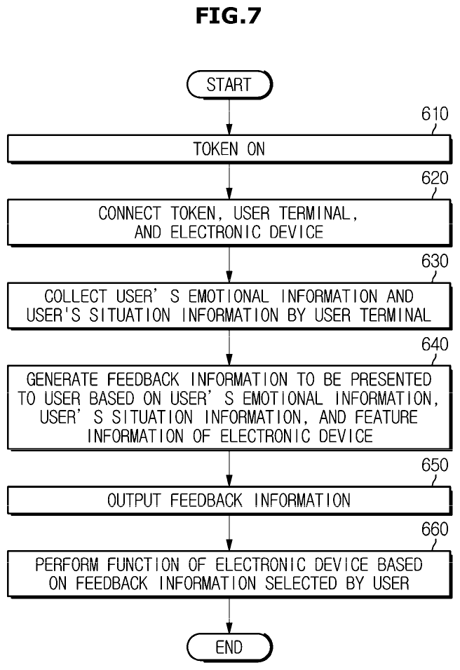

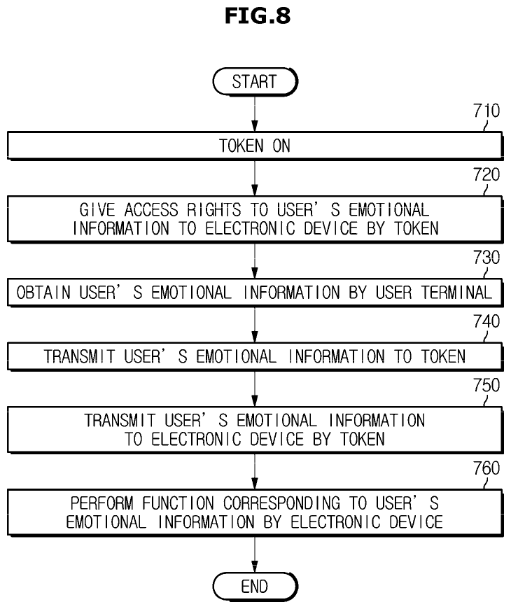

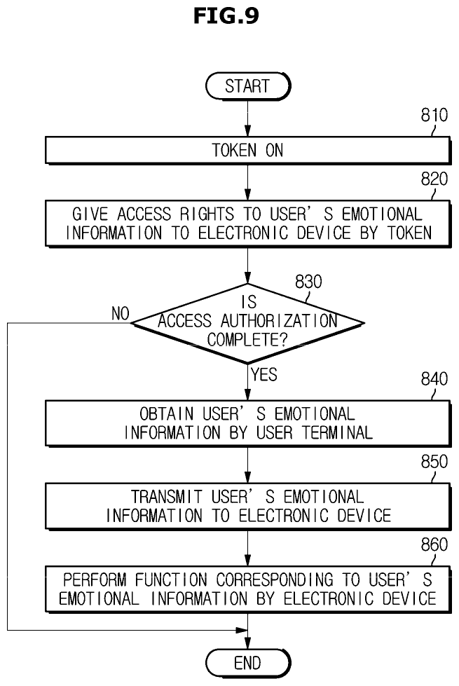

FIGS. 7 to 9 are flowcharts for describing a method of controlling a multi device system according to an exemplary embodiment of the present disclosure. FIGS. 7 to 9 illustrate the case where the token 100 is implemented in hardware.

As described above, the multi-device system 10 may comprise the token 100, the user terminal 200, and the electronic device 300.

First, the token 100 may be operated (610, 710, 810) and the token 100, the user terminal 200, and the electronic device 300 may be connected (620). The token 100 may be connected with the electronic device 300 and give the access rights to the user's emotional information to the electronic device 300.

The token 100 may give the access rights to the user's emotional information given by the user to the electronic device 300 (720). In addition, the token 100 may give the access rights to the user's emotional information to the electronic device 300, and may generate the access authorization completion signal and transmit the access authorization completion signal to the user terminal 200 (830). The user terminal 200 may confirm whether the access rights to the user's emotional information is given to the electronic device 300 (830).

When the user gives the access rights to his/her own emotion information to the electronic device 300 using the token 100, the user terminal 200 may obtain the user's emotional information from the data collected by the bio-signal sensor 210, the camera 220, etc. (630, 730, 840). The user terminal 200 may also collect the user's situation information including at least one of current location, current time, weather, and user schedule information through the external server (not shown) or the input device 270.

The user terminal 200 may transmit the obtained user's emotional information to the token 100 or the electronic device 300 (740, 850). When the user's emotional information is transmitted to the token 100, the token 100 may transmit the received user's emotional information back to the electronic device 300 (750).

Thereafter, the electronic device 300 may perform the function corresponding to the received user's emotional information (760, 860). The electronic device 300 may perform the specific function corresponding to the user's emotional information under the control of the user terminal 200.

The user terminal 200 may generate the feedback information to be presented to the user based on the user's emotional information, the users situation information, and the feature information of the electronic device 300 (640), and may output the feedback information through the output device 250 and provide the feedback information to the user (650). The feedback information may include at least one of the function information of the executable electronic device 300 corresponding to the user's emotional information and the emotional expression image corresponding to the user's emotional information.

When the user selects the feedback information using the user terminal 200, the user terminal 200 may generate the control signal corresponding to the feedback information and transmit the control signal to the electronic device 300. The electronic device 300 may receive the control signal from the user terminal 200 and perform the specific function included in the selected feedback information (660).

According to the multi device system and the method of controlling the multi device system as described above, there is an effect of preventing the user's emotional information from being used by the plurality of devices without the user's permission by the user selecting the device that can access his/her own emotion information using the token.

In addition, there is an effect of facilitating the interaction between the user and the plurality of devices by transmitting the user's emotional information through a medium called the token without adding a separate device for emotion recognition to each of the plurality of devices.

The disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A multi device system comprising:
a token configured to give access rights related to a user's emotional information to an electronic device; and
a user terminal configured to:
obtain the user's emotional information,
transmit the user's emotional information to the token, and
control the electronic device to which the access rights is given through the token to perform a function corresponding to the user's emotional information.

2. The multi device system according to claim 1, wherein the user terminal is configured to:
collect a user's bio-signal using a bio-signal sensor included in the user terminal, and
obtain the user's emotional information based on the user's bio-signal.

3. The multi device system according to claim 2, wherein the user terminal is further configured to:
further collect at least one of facial expression data of the user or gesture data of the user using a camera included in the user terminal, and
obtain the user's emotional information based on at least one of the user's bio-signal, the facial expression data of the user, or the gesture data of the user.

4. The multi device system according to claim 2, wherein the user terminal is configured to classify a user's emotion according to a reference corresponding to the user's bio-signal and to obtain the user's emotional information based on the classification result.

5. The multi device system according to claim 2, wherein the token is configured to:
transmit the user's emotional information to the electronic device,
extract feature information of the electronic device, and
transmit the feature information to the user terminal, and
wherein the user terminal is configured to generate feedback information corresponding to the user's emotional information by reflecting the feature information of the electronic device.

6. The multi device system according to claim 5, wherein the user terminal is configured to:
communicate with an external server to further collect user's situation information including at least one of current location, current time, weather, or user schedule information, and
generate the feedback information by reflecting the users situation information.

7. The multi device system according to claim 5, wherein the feedback information comprises at least one of function information of the electronic device corresponding to the user's emotional information or an emotional expression image corresponding to the user's emotional information.

8. The multi device system according to claim 7, wherein the user terminal is configured to generate a control signal for performing a specific function, and to transmit the control signal to the electronic device when the specific function among the function information of the electronic device is selected by the user.

9. The multi device system according to claim 1, wherein the user terminal is configured to:
obtain an image of a space including the token and the electronic device, and
output an augmented reality image by overlapping feedback information with the image.

10. A multi device system comprising:
a user terminal configured to:
generate a virtual token that gives access rights to a user's emotional information according to the user's request, and
generate and output feedback information corresponding to the user's emotional information by obtaining the user's emotional information; and
an electronic device configured to:
obtain the access rights by receiving the virtual token from the user terminal, and
perform a function corresponding to the user's emotional information under the control of the user terminal.

11. A multi device system comprising:
a token configured to give access rights related to a user's emotional information to an electronic device; and
a user terminal configured to:
obtain the user's emotional information,
communicate with the token to confirm a state that the access rights is given to the electronic device,
transmit the user's emotional information to the electronic device when the access rights is given to the electronic device, and
control the electronic device to perform a function corresponding to the user's emotional information.

12. A method of controlling a multi device system comprising:
connecting a token, a user terminal and an electronic device, and receiving access rights to a user's emotional information from the token;
providing, by the token, the access rights to the electronic device;
obtaining the user's emotional information using the user terminal, and transmitting, by the user terminal, the user's emotional information to the token; and
controlling, by the user terminal, the electronic device to perform a function corresponding to the user's emotional information by transmitting a control signal to the electronic device.

13. The method according to claim 12, wherein the transmitting the user's emotional information further comprises:
collecting a user's bio-signal; and
obtaining the user's emotional information based on the user's bio-signal.

14. The method according to claim 12, wherein the transmitting the user's emotional information further comprises:
transmitting the user's emotional information to the electronic device when a connection completion signal between the token and the electronic device is received at the user terminal.

15. The method according to claim 13, wherein the transmitting the user's emotional information further comprises:
collecting at least one of facial expression data of a user or gesture data of the user using a camera included in the user terminal; and
obtaining the user's emotional information based on at least one of the user's bio-signal, the facial expression data of the user, or the gesture data of the user.

16. The method according to claim 13, wherein the transmitting the user's emotional information further comprises:
classifying a user's emotion according to a reference corresponding to the user's bio-signal; and
obtaining the user's emotional information based on a classification result.

17. The method according to claim 13, further comprising:
generating, by the user terminal, feedback information corresponding to the user's emotional information by reflecting feature information of the electronic device extracted by the token.

18. The method according to claim 17, wherein the generating the feedback information further comprises:
communicating with an external server to collect user's situation information including at least one of current location, current time, weather, or user schedule information; and
generating the feedback information by reflecting the user's situation information.

19. The method according to claim 17, wherein the feedback information comprises at least one of function information of the executable electronic device corresponding to the user's emotional information or an emotional expression image corresponding to the user's emotional information.

20. The method according to claim 19, wherein the controlling the electronic device further comprises:
generating a control signal for performing a specific function; and
transmitting the control signal to the electronic device when the specific function among the function information of the executable electronic device is selected by a user.

21. A method of controlling a multi device system comprising:
generating, by a user terminal, a virtual token that gives access rights to a user's emotional information;
transmitting, by the user terminal, the virtual token to an electronic device to give the access rights to the electronic device;
obtaining the user's emotional information using the user terminal;
generating and outputting, by the user terminal, feedback information corresponding to the user's emotional information; and
performing, by the electronic device, a function corresponding to the user's emotional information under a control of the user terminal.

22. A method of controlling a multi device system comprising:
providing, by a token, access rights related to a user's emotional information to an electronic device;
communicating with the token, by a user terminal, to confirm a state that the access rights is given to the electronic device;
obtaining, by the user terminal, the user's emotional information;
transmitting, by the user terminal, the user's emotional information to the electronic device when the access rights is given to the electronic device; and
controlling, by the user terminal, the electronic device to perform a function corresponding to the user's emotional information.
